(19) United States
(12) Patent Application Publication
(10) Pub. No.: US 2006/0028416 A1
(43) Pub. Date: Feb. 9, 2006

(54) Display device and driving method for the same

(76) Inventors: Jun-Pyo Lee, Suwon-si (KR); Seung-Hwan Moon, Yongin-si (KR); Jung-Hwan Cho, Seongnam-si (KR)

Correspondence Address: CANTOR COLBURN, LLP, 55 GRIFFIN ROAD SOUTH, BLOOMFIELD, CT, 06002, US

(21) Appl. No.: 11/195,875

(22) Filed: Aug. 3, 2005

(30) Foreign Application Priority Data
Aug. 3, 2004 (KR) 10-2004-0061138

(51) Int. Cl. G09G 3/36

(52) U.S. Cl. 345/89

(57) ABSTRACT

A display device includes data lines transmitting data voltages, a signal controller processing image data from an external device and generating control signals, a gray voltage generator generating gray voltages, and a data driver selecting a gray voltage corresponding to image data from the signal controller and applying the gray voltages to the data lines as the data voltages. The signal controller compares present data with previous data of the image data and generates first to fourth mode setting signals for application to the data driver responsive to a result of the comparison.

This application claims priority to Korean Patent Application No. 2004-61138 filed on Aug. 3, 2004, and all the benefits accruing therefrom under 35 U.S.C §119, and the contents of which in its entirety are herein incorporated by reference.

### BACKGROUND OF THE INVENTION

(a) Field of the Invention

The present invention relates to a display device and a driving method for the same.

(b) Description of Related Art

Recently, flat panel display devices such as organic light emitting display (OLED) devices, plasma display panel (PDP) devices, and liquid crystal display (LCD) devices have been widely developed to replace heavy and large cathode ray tube (CRT) devices.

The PDP devices display characters or images using plasma generated by gas-discharge. The OLED devices display characters or images by applying an electric field to specific light emitting organics or high molecule materials. The LCD devices display images by applying an electric field to a liquid crystal layer disposed between two panels and regulating a strength of the electric field to adjust transmittance of light passing through the liquid crystal layer.

Among flat panel display devices, for example, the LCD and OLED devices each include a panel assembly provided with pixels including switching elements and display signal lines, a gray voltage generator generating a plurality of gray voltages, a data driver applying data voltages selected from the gray voltages supplied from the gray voltage generator to the data lines of the display signal lines, and a signal controller controlling the above-described elements.

Currently, a current driving scheme is used instead of a voltage driving scheme to transmit data from the signal controller to the data driver. Such current driving scheme uses a current corresponding to 3I (or three times a given current I) for transmitting data having a low value and a current corresponding to I for transmitting data having a high value, thereby transmitting logic values corresponding to “0” and “1”, respectively, to display desired information.

In such a case, an increase in a number of low values causes a larger current flow, thereby increasing power consumption relative to the high value. In particular, when a plurality of data driving integrated circuits comprising a data driver employing the current driving scheme are cascaded, power consumption of the data driver increases in proportion to a number of cascaded data driving integrated circuits.

### SUMMARY OF THE INVENTION

An object of the present invention is to provide a driving method of a display device and a display device capable of solving such conventional problems as those described above.

A display device is provided, which includes data lines transmitting data voltages, a signal controller processing image data from an external device and generating control signals, a gray voltage generator generating gray voltages, and a data driver selecting the gray voltage corresponding to image data from the signal controller and applying the gray voltages to the data lines as the data voltages. The signal controller compares present data with previous data of the image data and generates first to fourth mode setting signals for application to the data driver responsive to a result of the comparison.

A driving method of a display device including data lines transmitting data voltages, a signal controller processing image data from an external device and generating control signals, a gray voltage generator generating gray voltages, and a data driver selecting a gray voltage corresponding to image data from the signal controller and applying the gray voltages to the data lines as the data voltages, may include: comparing present data with previous data in the image data; setting modes responsive to a result of the comparison; and processing the present data in response to a mode setting of the setting modes.

### BRIEF DESCRIPTION OF THE DRAWINGS

The present invention will become more apparent by describing exemplary embodiments thereof in detail with reference to the accompanying drawings, in which:

FIG. 1 is a block diagram of a display device according to an exemplary embodiment of the present invention;

FIG. 2 illustrates a structure and an equivalent circuit diagram of a pixel of a liquid crystal display (LCD) device according to an exemplary embodiment of the present invention;

FIG. 3 is a schematic view of a display device according to an exemplary embodiment of the present invention;

FIG. 4 is a block diagram of a display device according to an exemplary embodiment of the present invention;

FIG. 5 is a flow chart to illustrate a driving method of a display device according to an exemplary embodiment of the present invention; and

FIG. 6 is a timing chart to illustrate a driving method of a display device according to an exemplary embodiment of the present invention.

### DETAILED DESCRIPTION OF THE INVENTION

The present invention now will be described more fully hereinafter with reference to the accompanying drawings, in which exemplary embodiments of the invention are shown. This invention may, however, be embodied in many different forms and should not be construed as limited to the embodiments set forth herein.

In the drawings, thicknesses of layers and regions are exaggerated for clarity. Like numerals refer to like elements throughout. It will be understood that when an element such as a layer, film, region, substrate, or panel is referred to as being “on” another element, it can be directly on the other element or intervening elements may also be present. In contrast, when an element is referred to as being “directly on” another element, there are no intervening elements present.

A display device and a manufacturing method thereof according to embodiments of the present invention will be described with reference to the drawings.

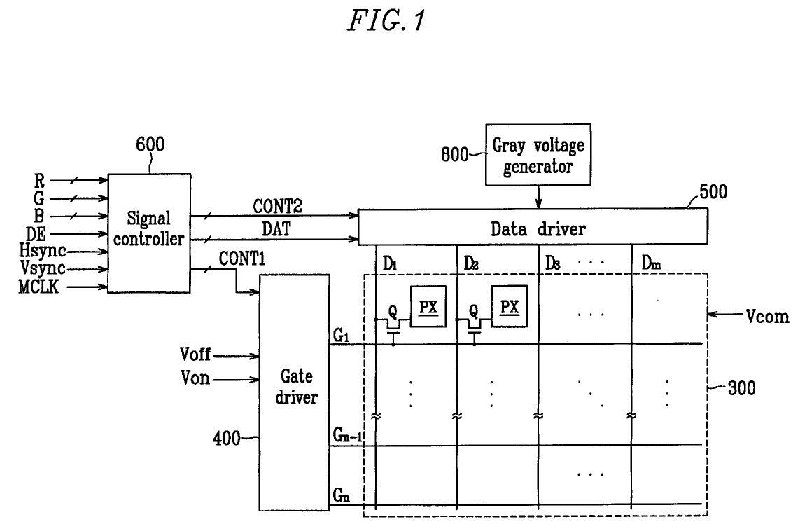

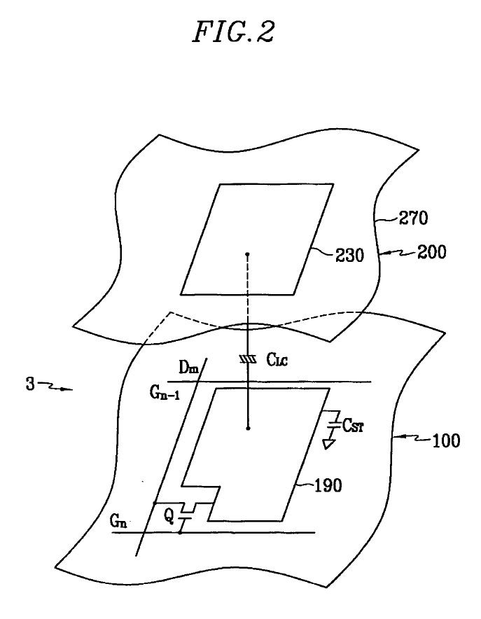

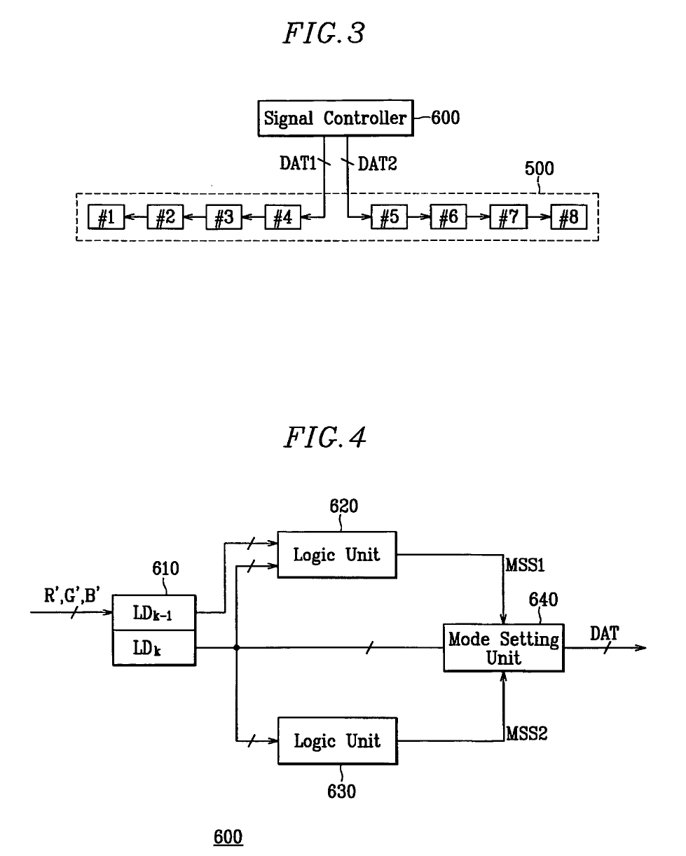

FIG. 1 is a block diagram of a display device according to an exemplary embodiment of the present invention. FIG. 2 illustrates a structure and an equivalent circuit diagram of a pixel of a liquid crystal display (LCD) device according to an exemplary embodiment of the present invention. FIG. 3 is a schematic view of a display device according to an exemplary embodiment of the present invention.

Referring to FIG. 1, a display device according to an exemplary embodiment of the present invention includes a panel assembly 300 having a gate driver 400 and a data driver 500 electrically connected thereto, a gray voltage generator 800 electrically connected to the data driver 500, and a signal controller 600 that controls the above-described elements.

Referring now to FIGS. 1 and 2, the panel assembly 300 includes a plurality of display signal lines G₁-Gₙ and D₁-Dₘ and a plurality of pixels electrically connected to corresponding ones of the display signal lines G₁-Gₙ and D₁-Dₘ and arranged substantially in a matrix structure. The panel assembly 300 includes a lower panel 100 and an upper panel 200.

The display signal lines G₁-Gₙ and D₁-Dₘ are provided on the lower panel 100, and include gate lines G₁-Gₙ transmitting gate signals (also called scanning signals) and data lines D₁-Dₘ transmitting data signals. The gate lines G₁-Gₙ extend substantially in a row direction and are substantially parallel to each other, while the data lines D₁-Dₘ extend substantially in a column direction and are substantially parallel to each other.

Each pixel includes a switching element Q electrically connected to one of the gate lines G₁-Gₙ and one of the data lines D₁-Dₘ, and pixel circuits PX electrically connected to the switching element Q. The switching element Q is provided on the lower panel 100 and has three terminals: a control terminal electrically connected to one of the gate lines G₁-Gₙ; an input terminal electrically connected to one of the data lines D₁-Dₘ; and an output terminal electrically connected to the pixel circuit PX.

In active matrix LCD devices, which are an example of a flat panel display device, the panel assembly 300 includes the lower panel 100, the upper panel 200, and a liquid crystal (LC) layer 3 disposed between the lower and upper panels 100 and 200, and the display signal lines G₁-Gₙ and D₁-Dₘ and switching elements Q are provided on the lower panel 100. Each pixel circuit PX includes an LC capacitor C_{LC} and a storage capacitor C_{ST} that are electrically connected in parallel with the switching element Q. The storage capacitor C_{ST} may be omitted if it is not needed.

The LC capacitor C_{LC} includes a pixel electrode 190 disposed on the lower panel 100, a common electrode 270 disposed on the upper panel 200, and the LC layer 3 as a dielectric between the pixel and common electrodes 190 and 270. The pixel electrode 190 is electrically connected to the switching element Q, and the common electrode 270 covers an entire surface of the upper panel 200 and is supplied with a common voltage Vcom. Alternatively, both the pixel electrode 190 and the common electrode 270, which have shapes of bars or stripes, are provided on the lower panel 100.

The storage capacitor C_{ST} is an auxiliary capacitor for the LC capacitor C_{LC}. The storage capacitor C_{ST} includes the pixel electrode 190 and a separate signal line (not shown), which is provided on the lower panel 100 and overlaps the pixel electrode 190 with an insulator disposed between the pixel electrode 190 and the separate signal line. The storage capacitor C_{ST} is supplied with a predetermined voltage such as the common voltage Vcom. Alternatively, the storage capacitor C_{ST} includes the pixel electrode 190 and an adjacent gate line called a previous gate line, which overlaps the pixel electrode 190 with an insulator disposed between the pixel electrode 190 and the previous gate line.

For a color display, each pixel uniquely represents one of three primary colors such as red, green, and blue colors (spatial division) or sequentially represents the three primary colors in time (temporal division), thereby obtaining a desired color. FIG. 2 shows an example of the spatial division in which each pixel includes a color filter 230 representing one of the three primary colors in an area of the upper panel 200 facing the pixel electrode 190. Alternatively, the color filter 230 is provided on or under the pixel electrode 190 on the lower panel 100.

A pair of polarizers (not shown) for polarizing light are attached on outer surfaces of the lower and upper panels 100 and 200 of the panel assembly 300.

Referring again to FIG. 1, the gray voltage generator 800 generates one set or two sets of gray voltages related to a transmittance of the pixels. When two sets of the gray voltages are generated, the gray voltages in one set have a positive polarity with respect to the common voltage Vcom, while the gray voltages in the other set have a negative polarity with respect to the common voltage Vcom.

The gate driver 400 synthesizes a gate-on voltage Von and a gate-off voltage Voff to generate gate signals for application to the gate lines G₁-Gₙ. The gate driver 400 is a shift register, and includes a plurality of stages in a line. The gate driver 400 is formed together with switching elements Q of the pixels PX to be integrated. Alternatively, the gate driver 400 may be mounted in an integrated circuit.

The data driver 500 is electrically connected to the data lines D₁-Dₘ of the panel assembly 300 and applies data voltages selected from the gray voltages supplied from the gray voltage generator 800 to the data lines D₁-Dₘ. As shown in FIG. 3, the data driver 500 includes a plurality of data driving integrated circuits (ICs). For example, FIG. 3 shows first to eighth ICs #1-#8, in which the first to fourth ICs #1-#4 and the fifth to eighth ICs #5-#8 are cascaded, respectively. The signal controller 600 controls the gate driver 400 and the data driver 500.

Operation of the display device will now be described in detail referring to FIGS. 1 and 3.

The signal controller 600 is supplied with image signals R, G, and B and input control signals controlling a display of the image signals R, G, and B. The input control signals include, for example, a vertical synchronization signal Vsync, a horizontal synchronization signal Hsync, a main clock MCLK, and a data enable signal DE from an external graphic controller (not shown). After generating gate control signals CONT1 and data control signals CONT2 and processing the image signals R, G, and B to be suitable for operation of the panel assembly 300 in response to the input control signals, the signal controller 600 provides the gate control signals CONT1 to the gate driver 400, and processed image signals DAT and the data control signals CONT2 to the data driver 500.

In such a case, the processed image signals DAT are inputted to the first to fourth data driving ICs #1-#4 and the fifth to eighth data driving ICs #5-#8 after being divided into first image signals DAT1 and second image signals DAT2, respectively, as shown in FIG. 3. Additionally, the first and second image signals DAT1 and DAT2 are current signals, and a current corresponding to I flows when bits forming data have high values but a current corresponding to 3I, which is three times I, flows when bits have low values.

The gate control signals CONT1 include a vertical synchronization start signal STV for informing the gate driver 400 of a start of a frame, a gate clock signal CPV for controlling an output time of the gate-on voltage Von, and an output enable signal OE for defining a width of the gate-on voltage Von.

The data control signals CONT2 include a horizontal synchronization start signal STH for informing the data driver 500 of a start of a horizontal period, a load signal LOAD or TP for instructing the data driver 500 to apply appropriate data voltages to the data lines D₁-Dₘ, and a data clock signal HCLK. The data control signals CONT2 may further include an inversion control signal RVS for reversing a polarity of the data voltages (with respect to the common voltage Vcom).

The data driver 500 receives the processed image signals DAT for a pixel row from the signal controller 600 and converts the processed image signals DAT into analogue data voltages selected from the gray voltages supplied from the gray voltage generator 800 in response to the data control signals CONT2 from the signal controller 600.

Responsive to the gate control signals CONT1 from the signal controller 600, the gate driver 400 applies the gate-on voltage Von to the gate lines G₁-Gₙ, thereby turning on the switching elements Q electrically connected to the gate lines G₁-Gₙ.

The data driver 500 applies the data voltages to corresponding data lines D₁-Dₘ for a turn-on time of the switching elements Q (which is called “one horizontal period” or “1H” and equals one period of the horizontal synchronization signal Hsync, the data enable signal DE, and the gate clock signal CPV). The data voltages in turn are supplied to corresponding pixels via turned-on switching elements Q.

A difference between the data voltage and the common voltage Vcom applied to a pixel is expressed as a charged voltage of the LC capacitor C_{LC}, i.e., a pixel voltage. Liquid crystal molecules of the LC layer 3 have orientations that vary responsive to a magnitude of the pixel voltage and the orientations determine a polarization of light passing through the LC capacitor C_{LC}. The polarizers convert light polarization into light transmittance.

By repeating the above-described procedure, all of the gate lines G₁-Gₙ are sequentially supplied with the gate-on voltage Von during a frame, thereby applying the data voltages to all pixels. In an exemplary embodiment of an LCD such as that shown in FIG. 1, when a next frame starts after finishing one frame, the inversion control signal RVS applied to the data driver 500 is controlled such that a polarity of the data voltages is reversed (“frame inversion”). The inversion control signal RVS may be controlled such that the polarity of the data voltages flowing in a data line in one frame is reversed (e.g.: “row inversion”, “dot inversion”), or the polarity of the data voltages in one packet is reversed (e.g.: “column inversion”, “dot inversion”).

A display device and a driving method thereof will now be described in detail with reference to FIGS. 4-6.

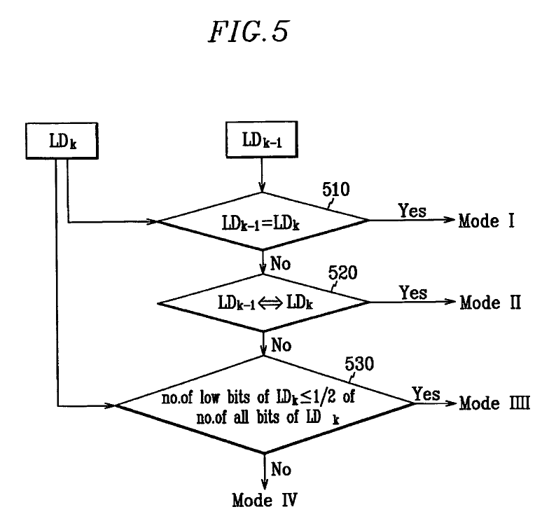

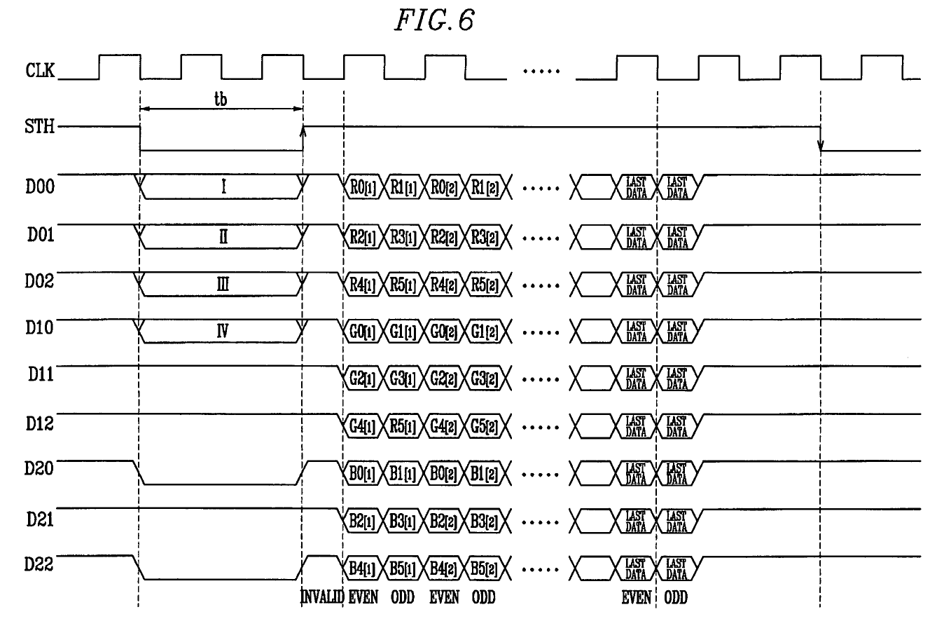

FIG. 4 is a block diagram of a display device according to an exemplary embodiment of the present invention. FIG. 5 is a flow chart to illustrate a driving method of a display device according to an exemplary embodiment of the present invention. FIG. 6 is a timing chart to illustrate a driving method of a display device according to an exemplary embodiment of the present invention.

As described above, the signal controller 600 provides the processed image signals DAT for the data driver 500, and, hereinafter, the processed image signals DAT are referred to as “line data”, represented as “LD”. In addition, for example, (k-1)-th line data are represented as “LDₖ₋₁” and k-th line data are represented as “LDₖ”.

In this case, when the k-th line data LDₖ is referred to as present data, (k-1)-th line data LDₖ₋₁ is previous data relative to the present data.

Referring to FIGS. 4 and 5, the signal controller 600 according to an exemplary embodiment of the present invention includes a line memory 610, a first logic unit 620 a second logic unit 630, and a mode setting unit 640.

The line memory 610 receives image data R′, G′, and B′ processed to be suitable for the operation of the panel assembly 300, and stores the present data LDₖ and the previous data LDₖ₋₁ of two pixel rows. The line memory 610 outputs the present data LDₖ to the first and second logic units 620 and 630 and the mode setting unit 640, and further outputs the previous data LDₖ₋₁ to the first logic unit 620.

The first logic unit 620 determines whether the present data LDₖ equals the previous data LDₖ₋₁ (at S510). If the present data LDₖ equals the previous data LDₖ₋₁, a first mode setting control signal MSS1 is transmitted to the mode setting unit 640 to set ‘Mode I.’

Subsequently, if the present data LDₖ is not equal to the previous data LDₖ₋₁, the first logic unit 620 determines whether the present data LDₖ have a complementary relationship with the previous data LDₖ₋₁ (at S520). If so, the first mode setting control signal MSS1 is transmitted to the mode setting unit 640 to set ‘Mode II.’ The complementary relationship means that each of bits forming corresponding data has a reversed relation with each other. For example, when data includes 6 bits and the previous data LDₖ₋₁ are “001010,” the present data LDₖ having the complementary relationship are “110101.”

The second logic unit 630 determines whether a number of bits with a low value is less than half of a number of all bits of the present data LDₖ (at S530). If the number of bits with the low value is less than half the number of all bits of the present data LDₖ, a second mode setting control signal MSS2 is transmitted to the mode setting unit 640 to set ‘Mode III.’ If the number of bits with the low value exceeds half the number of all bits of the present data LDₖ, the second mode setting control signal MSS2 is transmitted to the mode setting unit 640 to set ‘mode IV.’

The mode setting unit 640 sets modes of the present data LDₖ responsive to the first and second mode setting control signals MSS1 and MSS2.

Referring to FIG. 6, a clock signal CLK, a horizontal synchronization start signal STH, and signals of transmission lines D00-D22 are shown.

The clock signal CLK is the data clock signal HCLK as described above, and the transmission lines D00-D22 are lines transmitting data from the signal controller 600 to the data driver 500, of which three lines D00-D02 transmit red data R (for example, R0, R1, R2, etc.), three lines D10-D12 transmit green data G (for example, GO, G1, G2, etc.), and three lines D20-D22 transmit blue data B (for example, B0, B1, B2, etc.). 6-bit data are shown as an example in FIG. 6, wherein each of the transmission lines D00-D22 transmits 2 bits of an even datum EVEN and an odd datum ODD.

In such a case, data begins to be inputted when a half clock elapses after a level of the horizontal synchronization start signal STH is changed from high to low. A time corresponding to a low interval of the horizontal synchronization start signal STH is a blank interval tb without the data, and the blank interval tb is used to set the Modes I-IV.

For example, for setting the Mode I, the blank interval tb of the transmission line D00 is made high, and for setting the Mode II, the blank interval tb of the transmission line D01 is made high. In addition, for setting the Mode III, the blank interval tb of the transmission line D02 is made high, and for setting the Mode IV, the blank interval tb of the transmission line D10 is made high. Of course, alternatively, the blank interval tb is made low or the other transmission lines D11-D22 are used.

The mode setting unit 640 outputs the present data LDₖ changed into a high level or does not output the present data LDₖ for the Modes I and II, and outputs the present data LDₖ unaltered for the Mode III, and reverses the present data LDₖ for output for the Mode IV.

The data driver 500 checks a state of each of the transmission lines D00-D10 to process the processed image signals DAT to be suitable for each mode for output to the data lines D₁-Dₘ. For example, the data driver 500 outputs the previous data LDₖ₋₁ unaltered for the Mode I, and reverses the previous data LDₖ₋₁ for output for the Mode II. In addition, the data driver 500 outputs the present data LDₖ unaltered for the Mode III and reverses the present data LDₖ for output for the Mode IV.

To summarize, for the Mode I, the mode setting unit 640 outputs the present data with a high level and the data driver 500 outputs the previous data LDₖ₋₁, and, for the Mode II, the mode setting unit 640 outputs the present data LDₖ with a high level and the data driver 500 reverses the previous data LDₖ₋₁ for output. For the Mode III, the mode setting unit 640 and the data driver 500 process the present data LDₖ like normal operations, and, for the Mode IV, the mode setting unit 640 reverses the present data and the data driver 500 reverses the present data LDₖ once more.

In this way, data with a low level transmitted via the transmission lines D00-D22 are minimized, thereby reducing power consumption. Particularly, since, for the Mode I or II, there is no data transmission or identical data are outputted, power consumption decreases and electromagnetic interference (EMI) is minimized without transition of the data as well. Transition of the data decreases to reduce noise, thereby reducing bypass capacitors provided on the transmission lines for the purpose of decreasing the noise. This is more useful for a display device such as a television set with a long distance between the signal controller 600 and the data driver 500.

As described above, transmission of the data with the low level is minimized to reduce power consumption, EMI, and noise.

While the present invention has been described in detail with reference to exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
data lines transmitting data voltages;
a signal controller processing image data from an external device and generating control signals;
a gray voltage generator generating gray voltages; and
a data driver selecting a gray voltage corresponding to image data from the signal controller and applying the gray voltages to the data lines as the data voltages,
wherein the signal controller compares present data with previous data of the image data and generates first to fourth mode setting signals for application to the data driver responsive to a result of the comparison.

2. The display of claim 1, wherein the signal controller generates the first mode setting signal in response to the present data being equal to the previous data, and generates the second mode setting signal in response to the present data having a complementary relationship with the previous data.

3. The display device of claim 2, wherein the present data and the previous data comprise bits having one of a first state and a second state,
wherein the signal controller generates the third mode setting signal in response to a number of the bits having the first state being less than half a number of all bits of the present data, and generates the fourth mode setting signal in response to the number of the bits having the first state exceeding half the number of all bits of the present data.

4. The display device of claim 3, wherein the signal controller causes the bits in the present data to have the second state when the signal controller generates one of the first mode setting signal and the second mode setting signal.

5. The display device of claim 3, wherein the signal controller does not output the present data when the signal controller generates one of the first mode setting signal and the second mode setting signal.

6. The display device of claim 4, wherein the data driver applies the previous data to the data lines in response to the first mode setting signal.

7. The display device of claim 5, wherein the data driver applies the previous data to the data lines in response to the first mode setting signal.

8. The display device of claim 4, wherein the data driver reverses a state of each of the bits of the previous data for application to the data lines in response to the second mode setting signal.

9. The display device of claim 5, wherein the data driver reverses a state of each of the bits of the previous data for application to the data lines in response to the second mode setting signal.

10. The display device of claim 3, wherein the signal controller reverses a state of each of the bits of the present data for output in response to the signal controller generating the fourth mode setting signal.

11. The display device of claim 10, wherein the data driver reverses a state of each of the bits of the present data for application to the data lines.

12. The display device of claim 3, wherein the control signals comprise a horizontal synchronization start signal, and the first to the fourth mode setting signals are set at a time synchronized with a low interval of the horizontal synchronization start signal.

13. The display device of claim 12, wherein the data driver comprises a plurality of groups, each of the groups comprising data driving integrated circuits connected to each other.

14. The display device of claim 13, wherein the signal controller and the data driver communicate with each other using a current driving scheme.

15. The display device of claim 14, wherein a current flow in the first state is greater than a current flow in the second state.

16. A driving method of a display device comprising data lines transmitting data voltages, a signal controller processing image data from an external device and generating control signals, a gray voltage generator generating gray voltages, and a data driver selecting a gray voltage corresponding to image data from the signal controller and applying the gray voltages to the data lines as the data voltages, the method comprising:
comparing present data with previous data of the image data;
setting modes responsive to a result of the comparison; and
processing the present data in response to a mode setting determined by the setting modes.

17. The driving method of the display device of claim 16, wherein the comparison of the present data with the previous data comprises:
determining whether the present data equals the previous data; and
determining whether the present data have a complementary relationship with the previous data.

18. The driving method of the display device of claim 17, wherein the present data and the previous data comprise one of a first state and a second state,
wherein the comparison of the present data with the previous data further comprises determining whether a number of bits having the first state in the present data is less than half of a number of all bits of the present data.

19. The driving method of the display device of claim 18, wherein the setting modes responsive to the result of the comparison comprises:
setting a first mode when the present data equals the previous data;
setting a second mode when the present data have a complementary relationship with the previous data;
setting a third mode when the number of bits having the first state is less than half the number of all bits of the present data; and
setting a fourth mode when the number of bits having the first state exceeds half the number of all bits in the present data.

20. The driving method of the display device of claim 19, wherein the processing the present data in response to the mode setting comprises the signal controller causing all of the bits of the present data to have the second state for output in one of the first mode and the second mode.

21. The driving method of the display device of claim 19, wherein the processing the present data in response to the mode setting comprises the signal controller not outputting the present data in one of the first mode and the second mode.

22. The driving method of the display device of claim 20, wherein the processing the present data in response to the mode setting comprises:
the signal controller outputting the present data unaltered in the third mode; and
the signal controller reversing a state of each of the bits of the present data for output in the fourth mode.

23. The driving method of the display device of claim 21, wherein the processing the present data in response to the mode setting comprises:
the signal controller outputting the present data unaltered in the third mode; and
the signal controller reversing a state of each of the bits of the present data for output in the fourth mode.

24. The driving method of the display device of claim 22, wherein the data driver outputs the previous data unaltered in the first mode.

25. The driving method of the display device of claim 24, wherein the data driver reverses each of the bits of the previous data for output in the second mode.

26. The driving method of the display device of claim 25, wherein the data driver outputs the present data in the third mode.

27. The driving method of the display device of claim 26, wherein the data driver reverses each of the bits of the present data for output in the fourth mode.

28. The driving method of the display device of claim 19, wherein the signal controller generates a horizontal synchronization start signal for informing the data driver of an input start of the present data and the previous data,
wherein the first to the fourth mode are set at a time synchronized with a low interval of the horizontal synchronization start signal.

29. The driving method of the display device of claim 28, wherein the data driver comprises a plurality of groups, each of the groups comprising data driving integrated circuits electrically connected to each other.

30. The driving method of the display device of claim 29, wherein the signal controller and the data driver communicate with each other using a current driving scheme.

31. The driving method of the display device of claim 30, wherein a current flow in the first state is greater than a current flow in the second state.
